(19) United States
(12) Patent Application Publication
(10) Pub. No.: US 2020/0406935 A1
(43) Pub. Date: Dec. 31, 2020

(54) IN-CAR DISPLAY DEVICE OF AUTOMATIC DRIVING VEHICLE

(71) Applicant: Toyota Jidosha Kabushiki Kaisha, Toyota-shi (JP)

(72) Inventors: Yuchi Yamanouchi, Toyota-shi (JP); Masaki Shitara, Nagakute-shi (JP); Ryo Hattori, Kariya-shi (JP)

(21) Appl. No.: 16/910,459

(22) Filed: Jun. 24, 2020

(30) Foreign Application Priority Data
Jun. 28, 2019 (JP) 2019-121403

(51) Int. Cl. B60W 60/00; B60W 50/14; B60N 2/005; B60S 1/08; B60K 35/00

(52) U.S. Cl. CPC B60W 60/00253; B60W 50/14; B60N 2/005; B60S 1/08; B60K 2370/175; B60W 2300/10; B60W 2050/146; B60K 2370/152; B60K 2370/1434; B60K 35/00

(57) ABSTRACT

In the cabin of an automatic driving vehicle, a touch panel for inputting a control instruction in relation to the automatic driving vehicle and a display for displaying information on the automatic driving vehicle are provided. The touch panel and the display are disposed in the front end area in the end area in the vehicle width direction inside the cabin of the automatic driving vehicle such that their display surfaces are directed rearward. The touch panel is disposed further outward in the vehicle width direction than the display.

### CROSS REFERENCE TO RELATED APPLICATION

This application claims priority to Japanese Patent Application No. 2019-121403 filed on Jun. 28, 2019, which is incorporated herein by reference in its entirety including the specification, claims, drawings, and abstract.

### TECHNICAL FIELD

This specification discloses an in-car display device of an automatic driving vehicle.

### BACKGROUND

Conventionally, automatic driving vehicles adapted to automatic driving have been known. Automatic driving means that drive control including, for example, vehicle speed control or steering control is at least partially executed by a computer.

Conventionally, automatic driving vehicles include a touch panel for giving a control instruction relative to the automatic driving vehicle. For example, JP No. 2017-45104A and JP No. 2019-31138A disclose an automatic driving vehicle having a touch panel for controlling instruments (for example, a navigation system or an air conditioner) equipped to the automatic driving vehicle. JP No. 2018-135030A discloses an automatic driving vehicle having a touch panel for activating an automatic driving mode, or a driving mode for automatic driving.

As disclosed also in JP No. 2017-45104A, JP No. 2019-31138A, and JP No. 2018-135030A, in consideration of an occasion in which an operator operates a touch panel while manually driving an automatic driving vehicle, the touch panel is generally disposed on an instrument panel provided in the front area inside the cabin at the middle of the panel in the vehicle width direction so that the operator watching forward of the vehicle can see the touch panel by moving his/her eyes by only a small amount.

Here, we assume a case in which information (for example, the vehicle speed or outside temperature) of an automatic driving vehicle is displayed on a display device in the cabin of the vehicle. In the case where a touch panel is provided in the automatic driving vehicle, the information can be displayed on the touch panel. The touch panel, however, already displays various buttons for inputting control instructions to the automatic driving vehicle. Thus, additional display of a lot of information items on the automatic driving vehicle on the touch panel may make reduction in size of the buttons or close-packed display of the buttons or information inevitable. Otherwise, disposition of a plurality of buttons on a plurality of screens to be switched for display may be necessary. These can decrease operability of the touch panel.

Here, an automatic driving vehicle may be used as a bus-type vehicle in which many unspecified occupants ride. In this case, if a touch panel is operated by an occupant other than an operator responsible for operation of the touch panel, the automatic driving vehicle may operate in a manner not intended by the operator in some cases.

An object of an in-car display device of an automatic driving vehicle disclosed in this specification is to prevent decrease in operability of a touch panel for operating the automatic driving vehicle, and to prevent operation of a touch panel by an occupant other than an operator.

### SUMMARY

According to an aspect disclosed in this specification, there is provided an in-car display device of an automatic driving vehicle of bus-type, the automatic driving vehicle being capable of automatic driving and to be ridden by many unspecified people, the in-car display device including: a touch panel for an operator to input a control instruction relative to the automatic driving vehicle; and a display for displaying information on the automatic driving vehicle, wherein the touch panel and the display are disposed in the front end area in the end area in the vehicle width direction inside the cabin of the automatic driving vehicle such that the display surfaces are directed rearward, and the touch panel is disposed further outward in the vehicle width direction than the display.

According to the above-described structure, a display for displaying information on the automatic driving vehicle is provided in addition to the touch panel. This can reduce the amount of information on the automatic driving vehicle to be displayed on the touch panel, or allows display of no such information on the display panel. This can prevent decrease in operability of the touch panel.

The touch panel and the display are disposed in the front end area in the end area in the vehicle width direction inside the cabin of the automatic driving vehicle with their display surfaces directed rearward. Since the touch panel for operation by an operator is directed rearward, an operator is present at the rear of the touch panel. This can prevent an occupant other than the operator from moving closer to the display panel from the back area of the vehicle and operating the display panel. In addition, disposition of the touch panel further outward than the display in the vehicle width direction results in the touch panel being disposed farther away from the middle area of the cabin in the vehicle width direction, or a space for occupants. This can prevent an occupant from coming to the touch panel in the vehicle width direction and operating the touch panel.

The touch panel may be disposed further outward in the vehicle width direction than a pillar of the automatic driving vehicle, and the display may be disposed further inward in the vehicle width direction than the pillar.

The display device may further include a front seat for an occupant, the front seat being provided in the front end area inside the cabin of the automatic driving vehicle.

The display may be disposed to the side of the front seat.

The display device may further includes an operator seat for an operator to sit thereon, the operator seat being provided behind the touch panel.

The touch panel and the display may be disposed at the same level.

The touch panel may be provided on an armrest provided in the end area in the vehicle width direction inside the cabin of the automatic driving vehicle, and a part of the side wall of the automatic driving vehicle below the armrest is transparent.

The display device may further includes

a wiper motor provided forward of the display, the wiper motor being for operating a front wiper mounted on the front panel of the automatic driving vehicle, and a wiper arm penetrating the front panel to connect the wiper motor and the front wiper.

According to the in-car display device of an automatic driving vehicle disclosed in this specification, it is possible to prevent decrease in operability of the touch panel for operation of the automatic driving vehicle, and also to prevent operation of the touch panel by an occupant other than the operator.

### BRIEF DESCRIPTION OF DRAWINGS

Embodiment(s) of the present disclosure will be described based on the following figures, wherein:

FIG. 1 is a diagram illustrating the external appearance of an automatic driving vehicle according to an embodiment;

FIG. 2 is a first perspective view of the interior of the cabin of the automatic driving vehicle according to the embodiment;

FIG. 3 is a second perspective view of the interior of the cabin of the automatic driving vehicle according to the embodiment;

FIG. 4 illustrates a touch panel screen with the vehicle stopped;

FIG. 5 illustrates a touch panel screen with the vehicle in automatic running; and

FIG. 6 is a side view indicating the position of a wiper motor for operating a front wiper.

### DESCRIPTION OF EMBODIMENTS

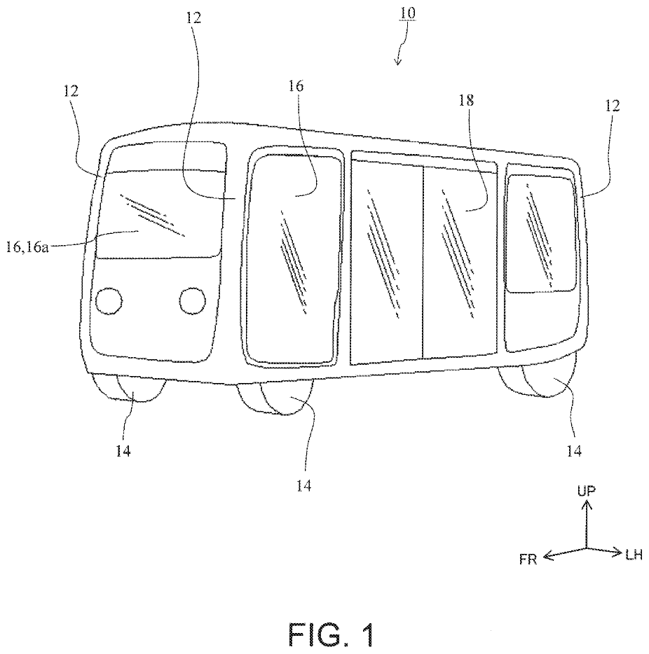

FIG. 1 illustrates the external appearance of an automatic driving vehicle 10 according to this embodiment. In the respective drawings in this specification, terms “front (FR)” and “rear” mean front and rear in the front-rear direction of the vehicle; terms “left (LH)” and “right” mean left and right when facing forward; and terms “up (UP)” and “down” mean up and down in the up-down direction of the vehicle.

The automatic driving vehicle 10 is shaped like a substantial rectangular parallelepiped that is front-rear symmetrical, whose external design as well is front-rear symmetrical. The automatic driving vehicle 10 has pillars 12 disposed at four respective corners in a plan view and extending in the up-down direction. Below each pillar 12, a wheel 14 is mounted. Alternatively, each pillar 12 may be disposed slightly further inward in the vehicle width direction (the right-left direction) than the respective corner in a plan view such that the right and left side walls are positioned further outward than the pillars 12 in the vehicle width direction. A large part of each of the front, rear, right, and left side walls of the automatic driving vehicle 10 is made from transparent or semi-transparent panels 16. The panel 16 may be a display panel, where letters or the like may be displayed.

Some panels 16 on the left side wall constitute a slidable automatic door 18. The automatic door 18 slidably opens so that an occupant can get on or off the vehicle. An extendable ramp is stored below the door 18, though not illustrated in FIG. 1. The ramp is used, for example, for an occupant in a wheelchair to get on or off the vehicle.

The automatic driving vehicle 10 is a vehicle adapted to automatic driving. Specifically, the automatic driving vehicle 10 can be driven in a plurality of driving modes, including an automatic driving mode, a semiautomatic driving mode, and a manual driving mode.

An automatic driving mode is a driving mode in which a majority of drive control is executed by a computer mounted in the automatic driving vehicle 10. In this specification, drive control is a concept encompassing gear shift control, vehicle speed control, and steering control. Vehicle speed control is a concept encompassing launch control, stop control, and acceleration/deceleration control of the automatic driving vehicle 10. The automatic driving vehicle 10 can communicate with a management center that manages and controls a plurality of automatic driving vehicles 10. In the automatic driving mode, the automatic driving vehicle 10 runs along a route determined in advance under control by the management center. In the automatic driving mode, although drive control is executed by a computer, following a driving instruction from the management center, launch control for launching the vehicle from a stopped state is executed by means of an operation by an operator in the automatic driving vehicle 10.

Similar to the automatic driving mode, a semiautomatic driving mode is a driving mode in which a majority of drive control of the automatic driving vehicle 10 is executed by a computer mounted in the automatic driving vehicle 10. In the semiautomatic driving mode, the computer executes drive control based on the results of detection by various sensors (for example, a camera or a lidar) mounted in the automatic driving vehicle 10, rather than on instructions from the management center, such that the vehicle runs along a predetermined route. In the semiautomatic driving mode as well, launch control for launching the vehicle from the stopped state is executed by means of an operation by the operator in the automatic driving vehicle 10.

A manual driving mode is a mode in which automatic driving of the automatic driving vehicle 10 is not executed, and the operator in the automatic driving vehicle 10 executes drive control of the automatic driving vehicle 10.

The automatic driving vehicle 10 is a bus in which many unspecified occupants ride. In this embodiment, the automatic driving vehicle 10 is utilized as a bus that runs along a predetermined route within a specified site to transport passengers. Thus, the automatic driving vehicle 10 is expected to repeat stop and launch at a relatively high frequency. In addition, the automatic driving vehicle 10 is expected to run at a relatively slow speed (for example, slower than 30 km/h).

Form of use of the automatic driving vehicle 10 disclosed in this specification, however, is arbitrarily changeable. That is, the automatic driving vehicle 10 can be utilized, for example, as a mobile business space, a sales outlet that displays and sells various products, or an eating outlet that serves cooked foods and drinks. Alternatively, as another form of use, the automatic driving vehicle 10 can be used as an office where people do office work or have meetings with clients. Occasions where the automatic driving vehicle 10 is utilized are not limited to business scenes, but the automatic driving vehicle 10 may be used, for example, as transportation means in private use. In addition, the running pattern and running speed of the automatic driving vehicle 10 can be arbitrarily changed.

The automatic driving vehicle 10 is an electric vehicle including a drive motor as a motor that receives electric power from a battery. The battery is a chargeable and dischargeable secondary battery, and regularly charged with power from an outside source. The automatic driving vehicle 10, however, is not limited to an electric vehicle, and may be a vehicle of any other type. For example, the automatic driving vehicle 10 may be an engine vehicle having an engine as a motor, or a hybrid vehicle having an engine and a drive motor as a motor. Alternatively, the automatic driving vehicle 10 may be a hydrogen vehicle that drives a drive motor with electric power generated by a fuel cell.

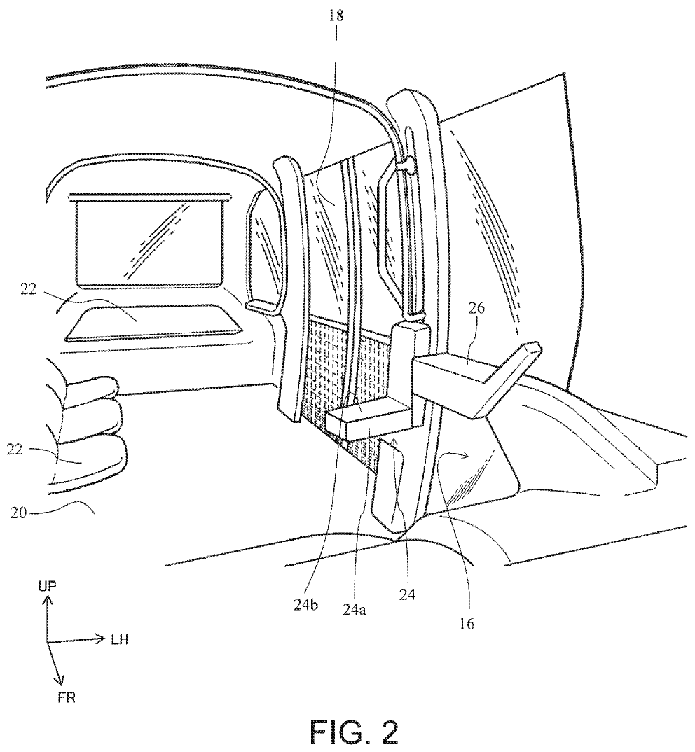

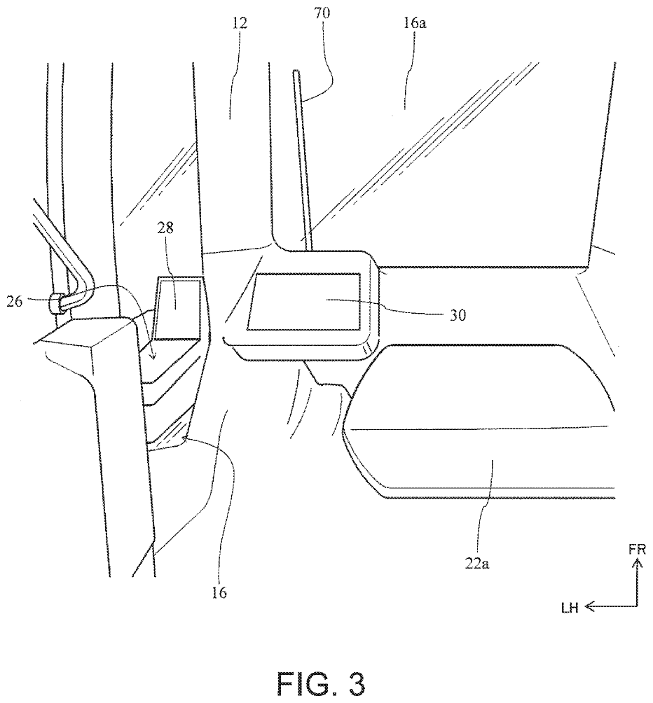

FIG. 2 and FIG. 3 are perspective views of the interior of the cabin of the automatic driving vehicle 10. As the automatic driving vehicle 10 is used as a bus, as described above, an area in the middle of the cabin makes a floor 20 where occupants stand or where a wheelchair with an occupant sitting therein is placed. Along the side wall in the cabin, seats 22 for occupants are provided.

The automatic driving vehicle 10 includes an operator seat 24 for an operator responsible for drive control of the automatic driving vehicle 10 and control of respective instruments (for example, an air conditioner or a wiper) of the automatic driving vehicle 10. In FIG. 2, a seat portion 24a of the operator seat 24 is flipped down such that a seat bottom 24b is seen. The seat portion 24a can be flipped up. The operator controls the automatic driving vehicle 10, while sitting on the operator seat 24 or standing near the operator seat 24.

In order for an occupant other than the operator to recognize that the operator seat 24 is a sear for an operator, a sign indicating that the operator seat 24 is a seat for an operator may be provided. Also, a space around the operator seat 24 may be defined as a space for an operator, and a sign indicating that the space is a space for an operator may be provided. Although in this embodiment the operator seat 24 is provided in the left end area near the front end area inside the cabin, the operator seat 24 may be provided in the right end area near the front end area inside the cabin.

In an end area in the vehicle width direction forward of the operator seat 24 in the cabin, there is provided an armrest 26 extending in the front-rear direction for an operator sitting on the operator seat 24 to place his/her arm. The front end portion of the armrest 26 extends to near the front end in the cabin. As the operator seat 24 is provided in the left end area in the cabin in this embodiment, as described above, the armrest 26 as well is disposed in the left end area in the cabin. If the operator seat 24 is provided in the right end area in the cabin, the armrest 26 as well is disposed in the right end area in the cabin. The armrest 26 is provided at a position higher than the seat bottom 24b of the operator seat 24 in a condition that allows an operator to sit on the seat bottom 24b.

The armrest 26 includes a mechanical operation unit (not illustrated) for inputting a drive control instruction in relation to the automatic driving vehicle 10. The mechanical operation unit can be stored in a storage unit (not illustrated) provided to the armrest 26. In this embodiment, the mechanical operation unit has a stick shape extending in the up-down direction and is capable of inclining in the front-rear and right-left directions with its lower end portion as a fulcrum. Inclining the mechanical operation unit either forward or rearward can accelerate or decelerate the automatic driving vehicle 10, while inclining the mechanical operation unit either rightward or leftward can turn the automatic driving vehicle 10 right or left. The mechanical operation unit may be operable in any driving mode of the automatic driving vehicle 10, and is used mainly in the manual driving mode.

The automatic driving vehicle 10 does not include a foot pedal, such as an acceleration pedal or a brake pedal, like those provided in conventional automobiles, to be operated with a foot to input a vehicle speed control instruction.

In the cabin of the automatic driving vehicle 10, a touch panel 28 for inputting a control instruction in relation to the automatic driving vehicle 10 and a display 30 for displaying information on the automatic driving vehicle 10 are provided (refer to FIG. 3).

The touch panel 28 displays various buttons, so that an operator can input a drive control instruction in relation to the automatic driving vehicle 10, by means of the buttons displayed on the touch panel 28. Specifically, a drive control instruction and an instrument control instruction in relation to an instrument (for example, a blinker, a horn, a headlight, an air conditioner, or a wiper) of the automatic driving vehicle 10 can be inputted, by means of the touch panel 28. In this embodiment, in particular, a vehicle speed control instruction among drive control instructions can be inputted via the touch panel 28.

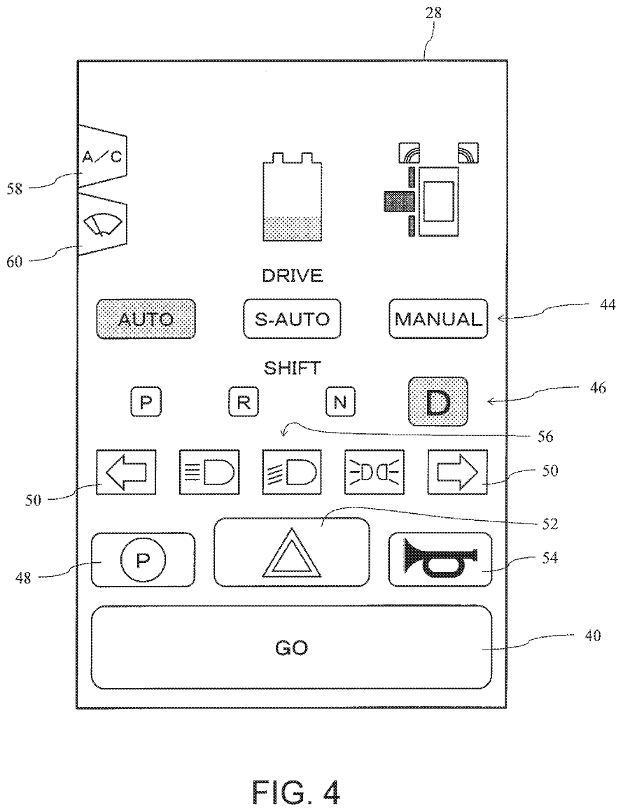

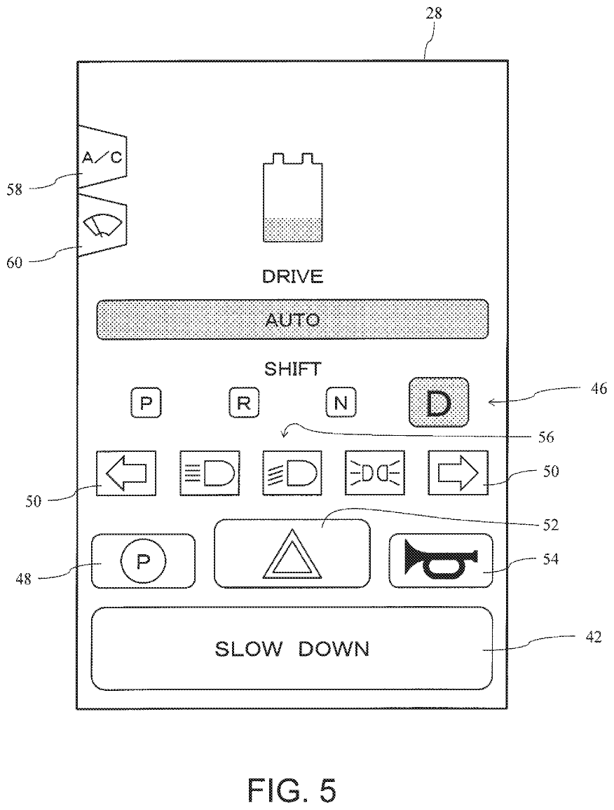

FIG. 4 and FIG. 5 illustrate a screen displayed on the touch panel 28. FIG. 4 illustrates a display screen displayed with the automatic driving vehicle 10 stopped in the automatic driving mode. FIG. 5 illustrates a display screen displayed with the automatic driving vehicle 10 running in the automatic driving mode.

As illustrated in FIG. 4, a GO button 40 is displayed on the touch panel 28 when the automatic driving vehicle 10 is stopped in the automatic driving mode. The GO button 40 is a button for inputting a launch instruction in relation to the automatic driving vehicle 10. That is, with the GO button 40 operated, the automatic driving vehicle 10 begins running (in the automatic driving mode in this case).

As illustrated in FIG. 5, a SLOW DOWN button 42 is displayed on the touch panel 28, instead of the GO button 40, when the automatic driving vehicle 10 is running in the automatic driving mode. The SLOW DOWN button 42 is a button for inputting a deceleration control instruction in relation to the automatic driving vehicle 10. That is, with the SLOW DOWN button 42 operated, the automatic driving vehicle 10 decelerates. Repetitive operations of the SLOW DOWN button 42 may be able to stop the automatic driving vehicle 10.

In this embodiment, an operator is allowed to input only a deceleration control instruction as a vehicle speed control instruction while the automatic driving vehicle 10 is in the automatic driving mode and running. Alternatively, a button for inputting an acceleration control instruction or a button for inputting a stop instruction may be displayed, in addition to the SLOW DOWN button 42, so that an operator can input an acceleration control instruction or a stop instruction. Needless to say, in the automatic driving mode, the automatic driving vehicle 10 can automatically decelerate or stop in response to an instruction from the management center. When the automatic driving vehicle 10 stops running, the GO button 40 appears again, instead of the SLOW DOWN button 42, as illustrated in FIG. 4.

In addition to the button for vehicle speed control, the touch panel 28 displays a driving mode button 44 for inputting a driving mode change instruction, a shift button 46 for inputting a gear shift control instruction, a P brake button 48 for inputting activation/release instruction in relation to an automatic parking brake, and various instrument control buttons for inputting instrument control instructions in relation to the instruments of the automatic driving vehicle 10. In the example illustrated in FIG. 4 and FIG. 5, a blinker button 50 for controlling a blinker, a hazard button 52 for causing a hazard indicator to operate, a horn button 54 for causing a horn to operate, a light button 56 for controlling a headlight and a taillight, an air conditioner tab 58 for controlling an air conditioner, and a wiper tab 60 for controlling a wiper are displayed as the instrument control buttons. With the air conditioner tab 58 touched, various buttons for controlling the air conditioner appear. With the wiper tab 60 touched, various buttons for controlling the wiper appear. The driving mode button 44 is operable only while the automatic driving vehicle 10 is stopped. In the automatic driving mode, the shift button 46 is not operable, as an operator is not allowed to shift gears in this embodiment.

In this embodiment, the touch panel 28 displays information on the automatic driving vehicle 10 in addition to the buttons for inputting control instructions in relation to the automatic driving vehicle 10. Specifically, as illustrated in FIG. 4 and FIG. 5, the residual amount of battery of the automatic driving vehicle 10, the open or close state of the door 18, the state of the ramp, and detection states of various sensors provided to the automatic driving vehicle 10, for example, are displayed.

The touch panel 28 displays minimum information to prevent decrease in operability of the touch panel 28. Alternatively, it may be the case that no information on the automatic driving vehicle 10 at all is displayed on the touch panel 28, and only a button for inputting a control instruction is displayed.

The display 30 displays, for example, information such as the vehicle speed, outside temperature, an image captured by a vehicle-mounted camera, or the next bus stop of the automatic driving vehicle 10. The display 30 is not a touch panel, and does not display an operable button. That is, it is not possible to operate the automatic driving vehicle 10 by means of the display 30. The display 30 is a display device for use by an operator, and a display device for use by occupants other than an operator is provided separately.

As described above, in addition to the touch panel 28, the display 30 for displaying information on the automatic driving vehicle 10 is provided in this embodiment, which can reduce the amount of information on the automatic driving vehicle 10 to be displayed on the touch panel 28. Alternatively, it may be the case that no information on the automatic driving vehicle 10 is displayed on the touch panel 28. With the above, it is unnecessary to reduce the size of a button for inputting a control instruction to be displayed on the touch panel 28, to closely display a plurality of buttons, or to display a plurality of buttons on a plurality of switchable screens, thereby preventing decrease in operability of the touch panel 28.

The touch panel 28 and the display 30 are disposed in the front end area in the end area in the vehicle width direction inside the cabin of the automatic driving vehicle 10 such that their display surfaces are directed rearward. In this embodiment, as illustrated in FIG. 3, the touch panel 28 and the display 30 are disposed at the left front corner in the cabin. The touch panel 28 is disposed further outward in the vehicle width direction (on the left side in this embodiment) than the display 30.

In this embodiment, the touch panel 28 is provided on the armrest 26. Specifically, the touch panel 28 is provided standing upright on the upper surface of the armrest 26 in the front end portion of the armrest 26. As described above, the armrest 26 is disposed in the left end area in the cabin such that its front end portion extends to near the front end in the cabin. Thus, the touch panel 28 as well is disposed in the left end area near the front end inside the cabin. As the armrest 26 is disposed forward of the operator seat 24, as described above, the operator seat 24 is positioned at the rear of the touch panel 28. This allows the operator to operate the touch panel 28 with his/her fingers while sitting on the operator seat 24 and resting his/her arm on the armrest 26.

In this embodiment, the display 30 is provided near the left end of the front wall of the automatic driving vehicle 10. As illustrated in FIG. 3, along the front wall of the automatic driving vehicle 10; that is, in the front end area inside the cabin, a front seat 22a for occupants other than an operator is provided. The display 30 is disposed to the side (on the left side in this embodiment) of the front seat 22a. The above-described disposition of the touch panel 28 in the left end area in the cabin results in the touch panel 28, the display 30, and the front seat 22a being aligned in this order from the outside (the left side in this embodiment) in the vehicle width direction.

The automatic driving vehicle 10 is a bus in which many unspecified occupants ride, as described above. A typical bus has a driver's space and passengers' space distinctively separated from each other so that a passenger cannot readily enter the driver's space. In the case where no driver's space is available or a driver's (an operator's) space continues to the passengers' space and a passenger can thus relatively readily enter the driver's space, as is in this embodiment, there is a possibility that a passenger other than the operator operates the touch panel 28. In this embodiment, however, the above-described disposition of the touch panel 28 and the display 30 makes it possible to prevent operation of the touch panel 28 by a passenger other than the operator, as will be described later.

Since the display surface (an operation surface) of the touch panel 28 for operation by the operator is directed rearward, the operator is usually present at the immediate rear of the touch panel 28. This prevents an occupant other than the operator from moving closer to the touch panel 28 from the back of the vehicle.

In particular, the operator seat 24 is provided behind the touch panel 28, and the space behind the touch panel 28 is defined as the operator's space in this embodiment. Provision of a sign indicating that the area behind the touch panel 28 is the operator's space can prevent an occupant other than the operator from entering the operator's space. Thus, it is possible to prevent an occupant from moving closer to the touch panel 28 from the back of the vehicle even while the operator is temporarily away from the position behind the touch panel 28.

In addition, the disposition of the touch panel 28 further outward than the display 30 in the vehicle width direction results in the touch panel 28 being disposed farther away from the middle area in the chamber, or the occupants' space, in the vehicle width direction. That is, the touch panel 28 is separated from the occupants' space at least by an extent corresponding to the width of the display 30. In particular, the touch panel 28 is separated from the front seat 22a in the front end area inside the cabin. This makes it possible to prevent an occupant from moving closer to the touch panel 28 in the vehicle width direction. Since approach of an occupant to the touch panel 28 in the vehicle width direction is prevented, as described above, the space up to the front end area inside the cabin is usable as the occupants' space, such as the front seat 22a.

In the case where the right and left side walls of the automatic driving vehicle 10 are positioned further outward than the pillars 12 in the vehicle width direction, the touch panel 28 may be disposed further outward than the pillar 12 in the vehicle width direction, and the display 30 may be disposed further inward than the pillar 12 in the vehicle width direction. Hence, the touch panel 28 is separated from the occupants' space by an extent corresponding to the combined widths of the display 30 and the pillar 12. That is, as the touch panel 28 is further separated from the occupants' space, it is possible to more reliably prevent an occupant from moving closer to the touch panel 28 in the vehicle width direction.

The above-described disposition of the touch panel 28 and the display 30 in the front end area in the end area in the vehicle width direction inside the cabin and disposition of the touch panel 28 further outward than the display 30 in the vehicle width direction make it possible to prevent an occupant other than the operator from moving closer to the touch panel 28 and operating the touch panel 28.

With the touch panel 28 provided on the front end portion of the armrest 26 and the display 30 provided near the left end of the front wall of the automatic driving vehicle 10, the touch panel 28 and the display 30 appear aligned when viewed from the back side of the vehicle. This disposition allows the operator to visually check both the touch panel 28 and the display 30.

In order to further enhance the visibility of the touch panel 28 and the display 30, the touch panel 28 and the display 30 may be disposed at the same level. Specifically, the touch panel 28 and the display 30 are disposed such that the upper end of the display 30 is positioned at the same level as that of the upper end of the touch panel 28, the lower end of the display 30 is positioned at the same level as that of the lower end of the touch panel 28, or the middle of the display 30 in the height direction is positioned at the same level as that of the touch panel 28 in the height direction.

A large part of the side wall of the automatic driving vehicle 10 is made from a transparent or semitransparent panel 16, as described above. That is, as illustrated in FIG. 2 and FIG. 3, a part of the side wall below the armrest 26 is from using a panel 16 to be transparent or semi-transparent. This allows the operator, sitting on the operator seat 24, to visually check the position below and to the side of the vehicle through the transparent portion of the side wall below the armrest 26. In particular, the operator can check the position below and to the side of the vehicle when opening or closing the door 18 or when the automatic driving vehicle 10 begins running.

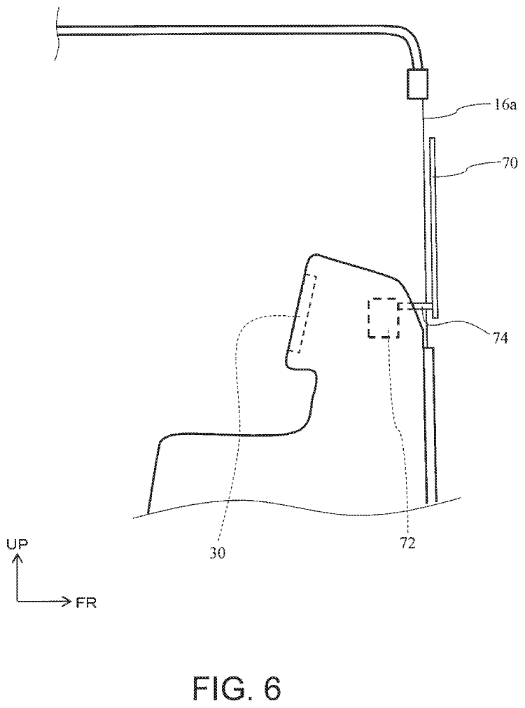

As illustrated in FIG. 3, a front wiper 70 is mounted on a front panel 16a. In FIG. 6, a position where a wiper motor 72 for operating the front wiper 70 is disposed is indicated. Specifically, as illustrated in FIG. 6, the wiper motor 72 is disposed forward of the display 30.

The wiper motor 72 has a wiper arm 74 extending forward to connect the front wiper 70 and the wiper motor 72. As the front wiper 70 is disposed outside the front panel 16a, and the wiper motor 72 is disposed on the side closer to the cabin than the front panel 16a, the wiper arm 74 penetrates the front panel 16a to connect the front wiper 70 and the wiper motor 72, so that the driving force of the wiper motor 72 is transmitted to the front wiper 70 via the wiper arm 74 so that the front wiper 70 operates.

The wiper motor 72 and the wiper arm 74 are hidden by the display 30 when viewed from the cabin.

Here, an outside area (the front view) which the operator can see via the front panel 16a is better to be wider. The wiper motor 72 for operating the front wiper 70, however, needs to be disposed near the front panel 16a, and thus can reduce the front view. In this embodiment, since the front view forward of the display 30 is originally not available due to the display 30 disposed in the front area of the vehicle, disposition of the wiper motor 72 forward of the display 30 does not further reduce the front view.

While an in-car display device of an automatic driving vehicle according to this disclosure has been described in the above, the in-car display device of an automatic driving vehicle according to this disclosure is not limited to the above-described embodiment, and can be modified in various manners not departing from the gist of the present disclosure.

1. An in-car display device of an automatic driving vehicle of bus-type, the automatic driving vehicle being capable of automatic driving and to be ridden by many unspecified people, the in-car display device comprising:
a touch panel for an operator to input a control instruction in relation to the automatic driving vehicle; and
a display for displaying information on the automatic driving vehicle,
wherein
the touch panel and the display are disposed in a front end area in an end area in a vehicle width direction inside a cabin of the automatic driving vehicle such that display surfaces thereof are directed rearward, and
the touch panel is disposed further outward in the vehicle width direction than the display.

2. The in-car display device of an automatic driving vehicle according to claim 1, wherein
the touch panel is disposed further outward in the vehicle width direction than a pillar of the automatic driving vehicle, and
the display is disposed further inward in the vehicle width direction than the pillar.

3. The in-car display device of an automatic driving vehicle according to claim 1, further comprising a front seat for an occupant, the front seat being provided in the front end area inside the cabin of the automatic driving vehicle, wherein
the display is disposed to a side of the front seat.

4. The in-car display device of an automatic driving vehicle according to claim 1, further comprising an operator seat for the operator to sit thereon, the operator seat being provided behind the touch panel.

5. The in-car display device of an automatic driving vehicle according to claim 1, wherein the touch panel and the display are disposed at the same level.

6. The in-car display device of an automatic driving vehicle according to claim 1, wherein
the touch panel is provided on an armrest provided in the end area in the vehicle width direction inside the cabin of the automatic driving vehicle, and
a part of a side wall of the automatic driving vehicle below the armrest is transparent.

7. The in-car display device of an automatic driving vehicle according to claim 1, further comprising:
a wiper motor provided forward of the display, the wiper motor being for operating a front wiper mounted on a front panel of the automatic driving vehicle, and
a wiper arm penetrating the front panel to connect the wiper motor and the front wiper.
